(19) United States
(12) Patent Application Publication
(10) Pub. No.: US 2018/0330598 A1
(43) Pub. Date: Nov. 15, 2018

(54) SYSTEMS AND METHODS FOR DYNAMIC HANDWASHING VERIFICATION

(71) Applicant: Jeffrey Scott Smith, Granbury, TX (US)

(72) Inventor: Jeffrey Scott Smith, Granbury, TX (US)

(21) Appl. No.: 15/978,863

(22) Filed: May 14, 2018

Related U.S. Application Data
(60) Provisional application No. 62/505,246, filed on May 12, 2017.

(51) Int. Cl. G08B 21/24

(52) U.S. Cl. CPC G08B 21/245; G06F 17/18

(57) ABSTRACT

Dynamically verifying handwashing compliance by caregivers may include identifying a generated handwashing communication that indicates a handwashing event time defining a time at which a handwashing event occurred. In response to receiving the generated handwashing communication, a patient visit time that defines a time at which a patient visit occurred may be determined. Determining a patient visit time may include receiving a patient visit communication that is sent in response to a determination that a caregiver computing device is physically proximate to a patient computing device. Based on the received handwashing communication and the determined patient visit time, the patient visit time may be determined as being within a time period threshold of the identified handwashing event time. A statistical analysis of a caregiver associated with the caregiver computing device may then be provided.

This application claims priority to and the benefit of U.S. Provisional Application No. 62/505,246, filed May 12, 2017, and entitled SYSTEMS AND METHODS FOR ENSURING HOSPITAL SANITIZATION AND PATIENT HOSPITAL INTEGRATION, the entire disclosure of which is incorporated herein by reference.

### BACKGROUND

Infections acquired by individuals within hospitals can be a serious problem. For instance, it has been estimated that the overall economic impact of hospital acquired infections exceeds ten billion dollars per year. Additional information obtained from the Center for Disease Control emphasizes the magnitude of the problem, including 2,500,000 hospital acquired infections per year in the U.S., 75,000 annual deaths, and $2500.00 average hospital expenditures per event.

Although it is appreciated that handwashing is likely the single most important intervention available to decrease the incidence of hospital acquired infections and simultaneously reduce the development of antimicrobial resistance, achieving compliance among health care workers is difficult. For example, although the need for improving handwashing compliance by health care workers is firmly established, compliance rarely exceeds forty percent. The most commonly cited reasons for non-compliance include the lack of role models and mere forgetfulness.

Accordingly, hospitals and other healthcare facilities continue to struggle with this problem. In an effort to improve compliance, many hospitals assign a member of the hospital staff to periodically observe whether the nursing staff is washing their hands before and after each patient visit. Unfortunately, such efforts have failed to initiate significant change in established habits and improve handwashing compliance. In addition, it can create an atmosphere in which nurses or doctors resent such observation by another member of the hospital staff.

While various other ideas may be considered or even employed, there continue to be serious drawbacks. For example, if one were to employ radiofrequency technology to aid in identifying when a nurse has visited a patient, and whether or not a handwashing event occurred in conjunction with the visit, there can still be problems with implementation. For example, if one were to provide a system that relies on proximity between the nurse and the handwashing station, such proximity sensors do not actually verify that the caregiver has actually placed any sanitizing solution onto their hands. In other words, the assumption would be that if a nurse is close enough to a handwashing station, a handwashing event occurred, which may not be the case.

For instance, a nurse might pass close by a handwashing station and pause long enough for the proximity to be recorded and a handwash credited, despite the caregiver never actually dispensing any soap or sanitizer onto their hands. In these instances, the system could be fooled into crediting for a hand wash when none had occurred. Any data collected from such a system would of course be suspect. Furthermore, even if a report were eventually run, significant time may pass between any given event and the availability of any such report.

### BRIEF SUMMARY

At least some embodiments described herein relate to methods, systems, and computer program products for dynamic, real-time verification of handwashing compliance by caregivers. Embodiments may include identifying a generated handwashing communication that indicates a handwashing event time defining a time at which a handwashing event occurred. In response to receiving the generated handwashing communication, a patient visit time that defines a time at which a patient visit occurred may be determined. Determining a patient visit time may include receiving a patient visit communication that is sent in response to a determination that a caregiver computing device is physically proximate to a patient computing device. Embodiments may further include, based on the received handwashing communication and the determined patient visit time, determining that the patient visit time is within a time period threshold of the identified handwashing event time. Embodiments may also include providing a statistical analysis of a caregiver associated with the caregiver computing device.

Accordingly, the principles described herein may allow for dynamically verifying that a caregiver has performed handwashing before and/or after a patient visit. In particular, the principles described herein allow for caregiver staff (e.g., nursing staff) to monitor compliance in real-time without the need for administrative review, ensuring that each caregiver has actually dispensed soap or hand sanitizer onto the hands before recording a handwashing event, distinguishing between handwashing events both before and after a patient visit. The principles described herein may also allow a hospital to designate patients as “soap only”, wherein the use of alcohol-based (or quat-based) sanitizer may be ineffective and thus inappropriate. Such principles may eliminate any requirement for a nurse to carry a separate radio frequency identification (RFID) badge, and eliminate any requirement for installing additional infrastructure (e.g., antennas) within a hospital or other healthcare facility.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates operation of the principles described herein.

FIG. 2 illustrates an example environment for dynamically verifying handwashing compliance by caregivers.

FIG. 3 illustrates a flowchart of a method for dynamically verifying handwashing compliance by caregivers.

### DETAILED DESCRIPTION

### I. Definitions

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or component not specified in the claim.

The terms “a,” “an,” “the” and similar referents used in the context of describing the inventive features (especially in the context of the following claims) are to be construed to cover both the singular and the plural, unless otherwise indicated herein or clearly contradicted by context. Thus, for example, reference to a “computing device” can include one, two or more such devices.

Numbers, percentages, ratios, or other values stated herein may include that value, and also other values that are about or approximately the stated value, as would be appreciated by one of ordinary skill in the art. For example, the stated values include values that are within 25%, 15%, 10%, within 5%, within 1%, etc. of a stated value.

Some ranges are disclosed herein. Additional ranges may be defined between any values disclosed herein as being exemplary of a particular parameter. All such ranges are contemplated and within the scope of the present disclosure. Further, recitation of ranges of values herein is intended to serve as a shorthand method of referring individually to each separate value falling within the range. Unless otherwise indicated herein, each individual value is incorporated into the specification as if it were individually recited herein.

All numbers expressing quantities as used in the specification and claims are to be understood as being modified in all instances by the term “about”.

Conditions, components, or steps not described as present herein may specifically be absent. For example, any of such that are not described as present in the present embodiments, may specifically be absent from the present processes and systems.

### II. Exemplary Systems, Methods and Products

At least some embodiments described herein relate to methods, systems, and computer program products for dynamically verifying handwashing compliance by caregivers. Embodiments may include identifying a generated handwashing communication that indicates a handwashing event time defining a time at which a handwashing event occurred. In response to receiving the generated handwashing communication, a patient visit time that defines a time at which a patient visit occurred may be determined. Determining a patient visit time may include receiving a patient visit communication that is sent in response to a determination that a caregiver computing device is physically proximate to a patient computing device. Embodiments may further include, based on the received handwashing communication and the determined patient visit time, determining that the patient visit time is within a time period threshold of the identified handwashing event time. Embodiments may also include providing a statistical analysis of a caregiver associated with the caregiver computing device.

Accordingly, the principles described herein may allow for dynamically verifying that a caregiver has performed handwashing before and/or after a patient visit. In particular, the principles described herein allow for caregiver staff (e.g., nursing staff) (i) to monitor compliance in real time without the need for administrative review, ensuring that each caregiver has actually dispensed soap or hand sanitizer onto the hands before recording a handwashing event, (ii) distinguishing between handwashing events both before and after a patient visit, (iii) to allow a hospital to designate patients as “soap only”, wherein the use of alcohol based or other sanitizer would be ineffective and thus inappropriate, (iv) eliminating any requirement for a nurse to carry a separate radio frequency identification (RFID) badge, and (v) eliminating any requirement for installing additional infrastructure (e.g., antennas) within a hospital or other healthcare facility.

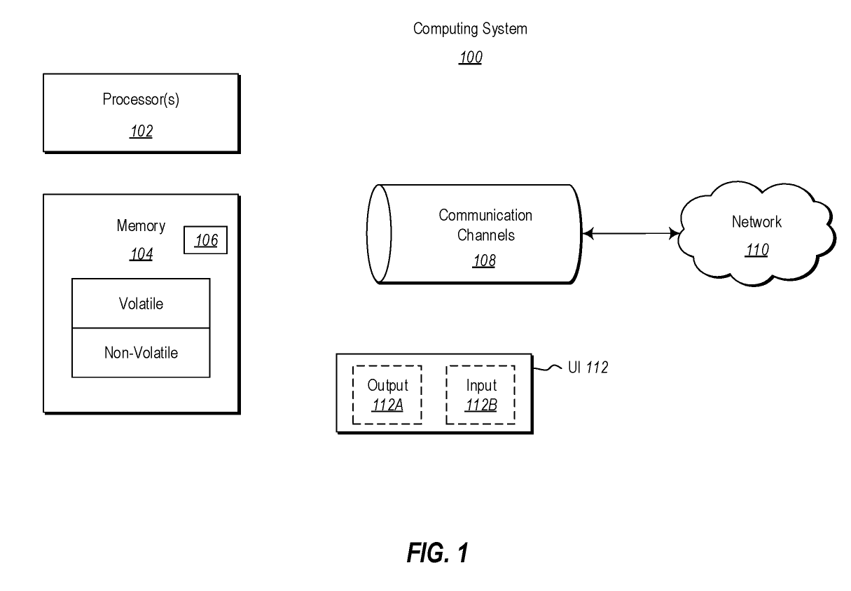

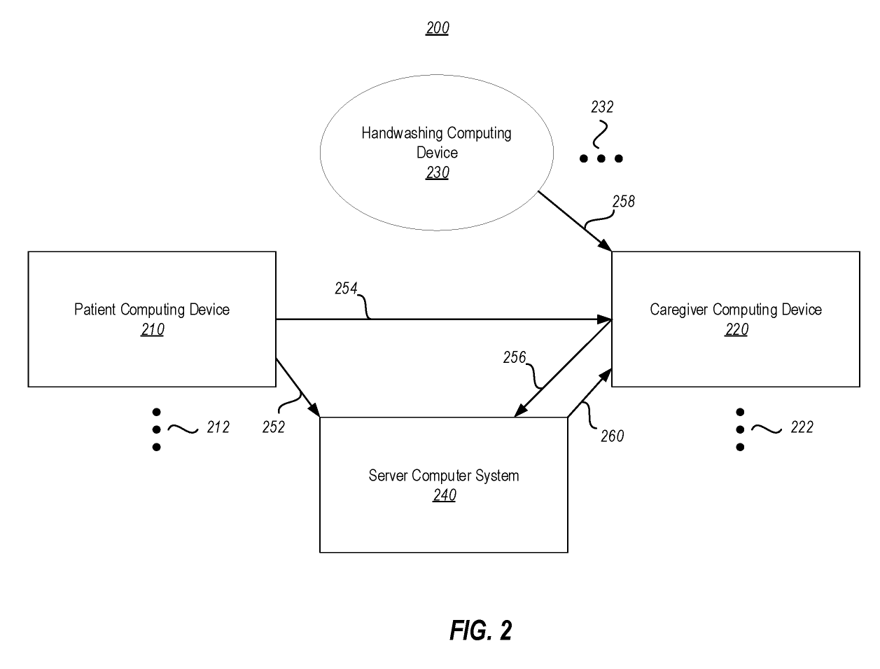

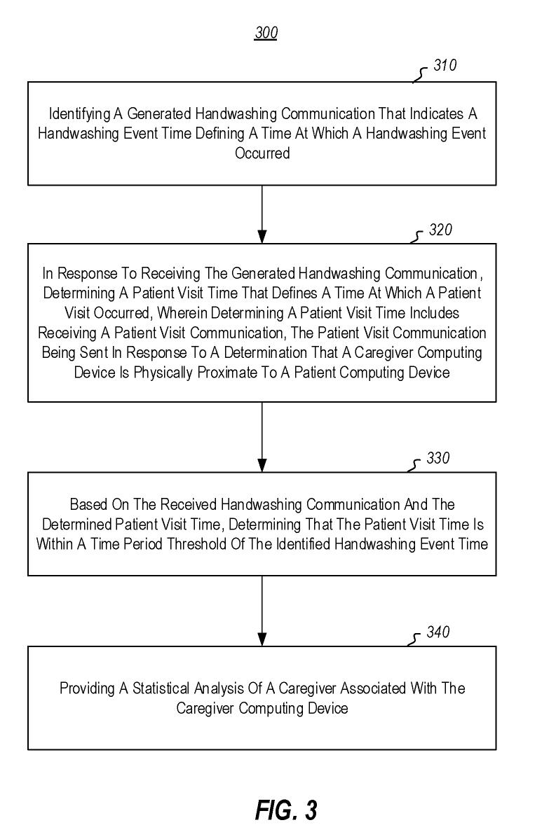

Some introductory discussion of a computing system will be described with respect to FIG. 1. Then, dynamically verifying handwashing compliance by caregivers, will be described with respect to FIGS. 2 and 3.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes NAND flash memory or other flash memory, RAM, DRAM, SRAM, ROM, EEPROM, CD-ROM or other optical disk storage, solid-state disk storage, magnetic disk storage or other storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an environment 200 for dynamically verifying handwashing compliance by caregivers (e.g., nurses and/or doctors within a hospital). As shown, the environment 200 includes a patient computing device 210, a caregiver computing device 220, a handwashing computing device 230, and a server computer system 240. The patient computing device 210 may comprise any type of computer system, including any combination of hardware and/or software that is configured to both transmit a continuous signal that is detectable by the caregiver computing device 220 and communicate with the server computer system 240, as further described herein. The patient computing device 210 may be embodied, for example, by computer system 100, as described with respect to FIG. 1. For instance, the patient computing device may comprise a tablet, a laptop, a desktop, a smartwatch, and so forth. In some embodiments, the patient computing device may comprise any type of computing device that includes a BLUETOOTH® transmitter. Both the patient and caregiver computing devices may be relatively small and portable (e.g., a tablet, smartphone, or the like).

Regardless of a type of device used as the patient computing device 210, each patient admitted within a healthcare environment (e.g., a hospital) may be provided with the patient computing device 210 (e.g., at check-in). Accordingly, while only one patient computing device 210 is illustrated within the environment 200, the ellipses 212 represent that any number of patient computing devices 210 may be utilized when practicing the principles described herein. In an example, the patient computing device provided to each given patient may be placed within the given patient's room (e.g., at the given patient's bedside). Each particular patient computing device may then connect to the server computer system 240 (as illustrated by arrow 252), such that the server computer system can uniquely identify each given patient and associate the given patient with the particular patient computing device. For instance, each given patient may be given, or create, a username and password/personal identification number (PIN) that allows the given patient to login to their provided patient computing device 210.

Notably, the server computer system 240 may comprise any type of computer system, including any combination of hardware and/or software that is configured to dynamically determine caregiver handwashing compliance, including receiving communications from the patient computing device 210, the caregiver computing device 220, and/or the handwashing computing device 230, as further described herein. In an example, the server computer system 240 may again be embodied by computer system 100, as described with respect to FIG. 1. Moreover, the server computer system may either be located on-site relative to the patient computing device 210 (e.g., on-site at a hospital), the caregiver computing device 220, and the handwashing computing device 230, or located remotely relative to such devices.

Along with connecting to the server computer system 240, the patient device 210 may also transmit an effectively continuous signal (as illustrated by arrow 254) using any applicable communication standard (e.g., BLUETOOTH) for physical proximity identification by the caregiver computing device 220. In other words, the patient computing device 210 (e.g., a tablet such as an iPad) may act as a transmitting beacon that can be received by the caregiver computing device 220 (e.g., a smartphone such as an iPhone) to determine a physical proximity between the patient computing device and the caregiver computing device, as further described herein.

Similar to the patient computing device 210, the caregiver computing device 220 may be provided to each caregiver (e.g., nurse, doctor, and so forth). Accordingly, while only one caregiver computing device 220 is illustrated within the environment 200, the ellipses 222 represent that any number of caregiver computing devices 220 may be utilized when practicing the principles described herein. Each caregiver computing device 220 may then be associated with a particular caregiver by the server computer system 240 (e.g., via a unique login, including username/password, biometrics, and so forth). Again, the caregiver computing device 220 may be embodied, for example, by computer system 100, as described with respect to FIG. 1. For instance, the caregiver computing device may comprise a tablet, laptop, desktop, a smartwatch, and so forth. In some embodiments, the caregiver computing device may comprise a mobile or handheld computing device that can be coupled to, or carried by, a caregiver. Each caregiver may have their own caregiver computing device 220. Each patient may have their own patient computing device 210. Regardless of the particular device type of the caregiver computing device 220, the caregiver computing device may comprise any type of computer system, including any combination of hardware and/or software that is configured to scan for, receive, and/or identify signals generated by the patient computing device 210 and the handwashing computing device 230, as well as sending and receiving communications with respect to the server computer system 240, as further described herein.

As briefly described, the patient computing device(s) 210 may continuously transmit a signal (e.g., a BLUETOOTH signal), which signal is detectable by the caregiver computing device(s) 220. In particular, when a caregiver having their particular caregiver computing device 220 comes within a particular physical proximity (e.g., between 1 and 10 feet) to a particular patient computing device 210, the caregiver computing device may identify such physically proximity. For instance, such a proximity determination may be based on a strength of a BLUETOOTH signal sent from the patient computing device 210. Notably, the interaction between the patient computing device 210 and the caregiver computing device 220 (i.e., the continuous signal/beacon generated by patient computing device and identified by the caregiver computing device) may include calibrating one or both of the patient computing device and the caregiver computing device to properly determine proximity.

In response to determining such proximity, the caregiver computing device 220 may communicate with the server computer system 240 (as illustrated by arrow 256). Based on such a communication, the server computer system may identify the current physical proximity of the particular caregiver computing device 220 to the particular patient computing device 210, thus determining that the caregiver associated with the particular caregiver computing device has visited the patient associated with the particular patient computing device. Such patient visits may then be recorded by the server computer system.

The patient computing device 210 may be provided to the patient not only for use in verifying handwashing of caregivers as provided herein, but for use in a “Patient Voice” type system as described in the provisional application, already incorporated herein by reference in its entirety.

As described herein, upon entering a patient room, a caregiver may often make physical contact with a patient, or other objects within the patient room. Accordingly, it may often be desirable that a caregiver washes their hands both prior to a patient visit and as soon as possible after the patient visit, as bacteria and other microbes are easily spread between patients and the patients' surroundings through the rounds made by such nurses or other caregivers.

Accordingly, as illustrated, environment 200 also includes the handwashing computing device 230. The handwashing computing device 230 may be included within each patient room and any other applicable areas within a healthcare environment. As such, while only one handwashing computing device 230 is illustrated within the environment 200, the ellipses 232 represent that any number of handwashing computing devices 230 may be utilized when practicing the principles described herein. Again, the handwashing computing device 230 may be embodied, for example, by computer system 100, as described with respect to FIG. 1. In particular, the handwashing computing device 230 may comprise any combination of hardware and/or software that is configured to generate a signal (as illustrated by arrow 258) that is detectable by the caregiver computing device 220 in response to determining that handwashing by a caregiver has occurred.

For instance, the caregiver computing device may comprise a BLUETOOTH enabled soap and/or sanitizer dispenser that is configured to transmit a BLUETOOTH signal in response determining that handwashing has occurred. In particular, the handwashing computing device 230 may transmit a signal (e.g., a BLUETOOTH signal) for a short period of time (e.g., between 1 and 10 seconds) after soap or sanitizer has been dispensed at the handwashing computing device. Such soap and/or sanitizer dispensing events may then indicate that a handwashing event has occurred. Notably, each handwashing computing device may include a unique identifier (e.g., a universally unique identifier (UUID), a media access control (MAC) address, a globally unique identifier (GUID), and so forth). Additionally, each handwashing computing device 230 may be configured to a generate a first signal associated with a soap dispensing event and a second signal associated with a sanitizer dispensing event. In a specific example, a given handwashing computing device may comprise a BLUETOOTH enabled soap and sanitizer dispenser having a UUID that utilizes major values to indicate a soap dispensing event and minor values to indicate a sanitizer dispensing event.

The caregiver computing device 220 may then receive and/or intercept the handwashing signal (as illustrated by the arrow 258) transmitted by the handwashing computing device 230, including identifying the particular handwashing computing device 230 that generated the signal (e.g., via the handwashing computing device's unique identifier) and the type of handwashing event that occurred (i.e., a soap dispensing event or a sanitizer dispensing event). The caregiver computing device 220 (or the handwashing computing device) may then communicate the detected handwashing event to the server computer system 240 (also illustrated by the arrow 256). Based on the communication, the server computer system 240 may be able to identify a type of handwashing event (e.g., a soap dispensing event or a sanitizer dispensing event) and the particular handwashing computing device 230 at which the handwashing event occurred.

In a particular example, the server computing system may identify the handwashing event type based on the major and/or minor values of a BLUETOOTH transmission by the handwashing computing device to the caregiver computing device, and may further identify the particular handwashing computing device based on a UUID of the handwashing computing device. In some embodiments, the caregiver computing device 220 may identify the handwashing type of a handwashing event and/or the identity of the particular handwashing computing device that generated the event and then communicate such identifications to the server computer system. In other embodiments, the caregiver computing device may simply pass communications associated with handwashing events generated by the handwashing computing device (e.g., passing the UUID, the major values, and/or minor values) on to the server computer system without making one or more of the identifications. Regardless of how the communication is performed, the server computer system may be capable of making such identifications and recording the handwashing event in association with the particular caregiver computing device, and potentially the particular handwashing computing device.

Based on timing associated with identified patient visits by a caregiver and generated handwashing events, the server computer system 240 may be configured to determine whether the caregiver performed handwashing before and/or after the identified patient visit. For instance, upon identifying that a handwashing event has occurred, the server computer system 240 may determine whether a patient visit has occurred (e.g., based on an identified physical proximity between the patient computing device and the caregiver computing device, as further described herein) within a certain time period or threshold (e.g., 30 seconds, or 1 minute) with respect to the identified handwashing event. Upon making such a determination (i.e., that a handwashing event has occurred within a time frame threshold of a patient visit), the server computer system may record the determination to be used for dynamic, real-time caregiver analytics. Similarly, the server 240 may also make determinations that handwashing events have not occurred within a specific time frame threshold and record such. Determinations that handwashing events have not occurred with respect to particular patient visits (e.g., either before or after a visit) may also be used for dynamic, real-time caregiver analytics.

Notably, while the patient computing device 210 continuously transmits a signal to any potential caregiver computing device 220 that is determined to be proximate the patient computing device, it may often take several seconds for a patient visitation to be recorded by the server computer system 240. Such a delay may occur, for example, because the caregiver computing device 220 may need a few seconds to sort through each BLUETOOTH signal within a given area. Accordingly, the caregiver computing device 220 may be delayed in determining that the patient computing device 210 is in range of the caregiver computing device before communicating such a determination to the server computer system 240. As such, a caregiver may be given a certain period of time (e.g., 30 seconds, or 1 minute) prior to a patient visit to perform a handwash, as well as certain period (e.g., 30 seconds, or 1 minute) after a patient visit has ended. Such time periods or thresholds can be easily adjusted (e.g., from 5 seconds to 3 minutes or the like), as desired for individual situations.

Notably, it may occasionally be necessary for a caregiver to use soap instead of an alcohol-based or other hand sanitizer. More particularly, certain pathogens are not effectively destroyed or removed without the use of soap and water. Accordingly, the environment 200 may allow a patient to be designated as a “soap only” patient. With respect to such patients, the server computer system 240 may not give a caregiver credit for either a pre-visit or post-visit handwash unless the server computer system receives a signal from either the handwashing computing device or the caregiver computing device indicating a soap dispensing event (and/or a water rinsing event). In a specific example, assume the server computer system has received a communication from the caregiver computing device 220 within a particular time period (e.g., within 30 seconds of an identified patient visit) of an identified visit to a “soap only” patient that indicates a sanitizer handwashing event has occurred (e.g., based on receiving a minor value associated with the handwashing computing device 230). In such a case, the server computer system 240 may determine that the detected sanitizer handwashing event is invalid, and therefore record that a valid handwashing event has not occurred in association with the particular detected patient visit and detected handwashing event.

The server computer system 240 may also be configured to send a real-time (i.e., essentially immediate) notification to the caregiver computing device 220 when the server computer system has determined that a patient visit has occurred (i.e., via communication between the patient computing device and caregiver computing device, as further described herein) and the caregiver associated with the caregiver computing device 220 has not performed a handwashing event (i.e., via communication from the handwashing computing device 230 transmitting a handwashing event signal). Such a real-time notification may alert the caregiver that a patient visit has been initiated without performing a handwashing event. After such a notification has been received, the caregiver may be given a time frame (e.g., 30 seconds, 1 minute, or the like) in which to perform a handwashing event, after which time the server computer system may record a non-compliant handwashing event with respect to the caregiver. Similarly, the server computer system may send a real-time notification to the caregiver computing device when the associated caregiver has not performed a handwashing event within a time frame threshold (e.g., 30 seconds, 1 minute, or the like) after a patient visit. Again, after such a notification has been received, the caregiver may be given another time frame (e.g., 30 seconds, 1 minute, or the like) in which to perform the needed handwashing event, after which time the server computer system may record a non-compliant handwashing event with respect to the caregiver.

The server computer system may also be configured to recognize when a caregiver has temporarily left a patient visit and promptly returns to finish the same patient visit. For instance, during a patient visit, a nurse may be called into a hallway briefly before returning to the patient's room to complete the patient visit. In such cases, it may not be necessary for the caregiver to perform another handwashing event until after the patient visit has actually completed. In an example, the server computer system may make such a determination based on a time frame threshold (e.g., between 1 second and 2 minutes) between the caregiver computing device losing a signal, or identifying a weakened signal, from the patient computing device (i.e., illustrating that the associated caregiver was performing a patient visit, but has left) and the caregiver computing device again identifying the same patient computing device signal with sufficient signal strength to determine that the patient visit is ongoing. In such cases, the server computer system may refrain from sending a real-time notification associated with alerting the caregiver to perform a handwashing event and/or may not record a non-compliant handwashing event associated with the caregiver.

Furthermore, the server computer system 240 may provide a statistical analysis of a particular caregiver's handwashing compliance throughout a shift or over another applicable time period (e.g., a week, a pay period, a month, and so forth). Aggregate analysis may also be provided (e.g., caregivers assigned to a particular shift, all caregivers over a week or month, etc.). Such an analysis (whether particularized or aggregate) may be provided via a user interface of the caregiver computing device 220. Additional reporting may also be provided via the caregiver computing device. Such real-time analysis of a caregivers performance/compliance may further aid in the development and improvement in caregiver handwashing habits, as well as reducing any need for administrative intervention.

FIG. 3 illustrates a flowchart of a method 300 for dynamically verifying handwashing compliance by caregivers. The method 300 is described with frequent reference to the environments of FIG. 2. As shown, the method 300 includes identifying a generated handwashing communication that indicates a handwashing event time defining a time at which a handwashing event occurred (Act 310). For instance, the server computer system 240 may receive a communication from the caregiver computing device 220 associated with a handwashing event. Notably, the communication from the caregiver computing device may be based on a signal/communication transmitted by the handwashing computing device 230 in response to detecting that a handwashing event (e.g., a soap dispensing event and/or a sanitizer dispensing event) has occurred at the handwashing computing device. Additionally, the handwashing event/communication may be associated with a particular caregiver.

The method 300 may further include, in response to receiving the generated handwashing communication, determining a patient visit time that defines a time at which a patient visit occurred (Act 320). Determining a patient visit time may include receiving a patient visit communication that is sent in response to a determination that a caregiver computing device is physically proximate to a patient computing device. For instance, in response to receiving a handwashing communication from the caregiver computing device 220, the server computer system may identify each patient visit made by a particular caregiver associated with the caregiver computing device 220 and determine whether a handwashing event associated with the handwashing communication occurred with a particular time frame threshold of any detected patient visits by the particular caregiver. Notably, a detected patient visit may occur when the caregiver computing device detects a continuous signal sent by the patient computing device 220 at a particular signal strength, thus indicating both physical proximity between the patient computing device and the caregiver computing device, and a patient visit.

The method 300 may also include, based on the received handwashing communication and the determined patient visit time, determining that the patient visit time is within a time frame threshold of the identified handwashing event time (Act 330). For example, the server computer system 240 may identify that the handwashing event occurred within a time frame threshold of the detected patient visit. The method 300 may further include providing a statistical analysis of a caregiver associated with the caregiver computing device (Act 340). For example, the server computer system may analyze recordings of valid handwashing events having occurred within a time frame threshold of patient visits associated with a particular caregiver and provide such analysis to the caregiver computing device 220, and ultimately the particular caregiver associated with the caregiver computing device.

Accordingly, the principles described herein may allow for dynamically verifying that a caregiver has performed handwashing before and/or after a patient visit. In particular, the principles described herein allow for caregiver staff (e.g., nursing staff) to monitor compliance in real-time without the need for administrative review, ensuring that each caregiver has actually dispensed soap or hand sanitizer onto the hands before recording a handwashing event, distinguishing between handwashing events both before and after a patient visit, a hospital to designate patients as “soap only”, wherein the use of alcohol based or other sanitizer would be ineffective and thus inappropriate, eliminating any requirement for a nurse to carry a separate radio frequency identification (RFID) badge, and eliminating any requirement for installing additional infrastructure (e.g., antennas) within a hospital or other healthcare facility.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more processors; and
one or more computer-readable storage media having stored thereon computer-executable instructions that are executable by the one or more processors to cause the computer system to dynamically verify handwashing compliance by caregivers, the computer-executable instructions including instructions that are executable to cause the computer system to perform at least the following:
identify a generated handwashing communication that indicates a handwashing event time defining a time at which a handwashing event occurred;
in response to receiving the generated handwashing communication, determine a patient visit time that defines a time at which a patient visit occurred, wherein determining a patient visit time includes receiving a patient visit communication, the patient visit communication being sent in response to a determination that a caregiver computing device is physically proximate to a patient computing device;
based on the received handwashing communication and the determined patient visit time, determine that the patient visit time is within a time period threshold of the identified handwashing event time; and
provide a statistical analysis of a caregiver associated with the caregiver computing device.

2. The computer system of claim 1, wherein the handwashing event includes identification of a handwashing event type.

3. The computer system of claim 2, wherein the handwashing event type comprises at least one of a soap handwashing event or a sanitizer handwashing event.

4. The computer system of claim 1, wherein identifying the handwashing communication includes:
a handwashing computing device generating a handwashing event signal in response to a soap dispensing event or a sanitizer dispensing event;
receiving the handwashing event signal at the caregiver computing device; and
sending the handwashing event signal to the server computer system.

5. The computer system of claim 4, wherein a first signal is associated with a soap dispensing event and a second signal is associated with a sanitizer dispensing event.

6. The computer system of claim 1, wherein the determination that a caregiver computing device is physically proximate to a patient computing device further includes:
the patient computing device sending a continuous signal that is identifiable by the caregiver computing device; and
determining, by the caregiver computing device, that the caregiver computing device is within a distance threshold of the caregiver computing device.

7. The computer system of claim 6, wherein determining that the caregiver computing device is within the distance threshold includes determining a signal strength of the continuous signal sent by the patient computing device at the caregiver computing device.

8. A method, implemented at a computer system including one or more processors, for dynamically verifying handwashing compliance by caregivers, the method comprising:
identifying a generated handwashing communication that indicates a handwashing event time defining a time at which a handwashing event occurred;
in response to receiving the generated handwashing communication, determining a patient visit time that defines a time at which a patient visit occurred, wherein determining a patient visit time includes receiving a patient visit communication, the patient visit communication being sent in response to a determination that a caregiver computing device is physically proximate to a patient computing device;
based on the received handwashing communication and the determined patient visit time, determining that the patient visit time is within a time period threshold of the identified handwashing event time; and
providing a statistical analysis of a caregiver associated with the caregiver computing device.

9. The method of claim 8, wherein the handwashing event includes identification of a handwashing event type.

10. The method of claim 9, wherein the handwashing event type comprises at least one of a soap handwashing event or a sanitizer handwashing event.

11. The method of claim 8, wherein identifying the handwashing communication includes:
a handwashing computing device generating a handwashing event signal in response to a soap dispensing event or a sanitizer dispensing event;
receiving the handwashing event signal at the caregiver computing device; and
sending the handwashing event signal to the server computer system.

12. The method of claim 11, wherein a first signal is associated with a soap dispensing event and a second signal is associated with a sanitizer dispensing event.

13. The method of claim 8, wherein the determination that a caregiver computing device is physically proximate to a patient computing device further includes:
the patient computing device sending a continuous signal that is identifiable by the caregiver computing device; and
determining, by the caregiver computing device, that the caregiver computing device is within a distance threshold of the caregiver computing device.

14. The method of claim 13, wherein determining that the caregiver computing device is within the distance threshold includes determining a signal strength of the continuous signal sent by the patient computing device at the caregiver computing device.

15. A computer program product comprising one or more computer readable media having stored thereon computer-executable instructions that are executable by one or more processors of a computer system to cause the computer system to dynamically verify handwashing compliance by caregivers, the computer-executable instructions including instructions that are executable to cause the computer system to perform at least the following:
identify a generated handwashing communication that indicates a handwashing event time defining a time at which a handwashing event occurred;
in response to receiving the generated handwashing communication, determine a patient visit time that defines a time at which a patient visit occurred, wherein determining a patient visit time includes receiving a patient visit communication, the patient visit communication being sent in response to a determination that a caregiver computing device is physically proximate to a patient computing device;
based on the received handwashing communication and the determined patient visit time, determine that the patient visit time is within a time period threshold of the identified handwashing event time; and
provide a statistical analysis of a caregiver associated with the caregiver computing device.

16. The computer program product of claim 15, wherein the handwashing event includes identification of a handwashing event type.

17. The computer program product of claim 16, wherein the handwashing event type comprises at least one of a soap handwashing event or a sanitizer handwashing event.

18. The computer program product of claim 15, wherein identifying the handwashing communication includes:
a handwashing computing device generating a handwashing event signal in response to a soap dispensing event or a sanitizer dispensing event;
receiving the handwashing event signal at the caregiver computing device; and
sending the handwashing event signal to the server computer system.

19. The computer program product of claim 18, wherein a first signal is associated with a soap dispensing event and a second signal is associated with a sanitizer dispensing event.

20. The computer program product of claim 15, wherein the determination that a caregiver computing device is physically proximate to a patient computing device further includes:
the patient computing device sending a continuous signal that is identifiable by the caregiver computing device; and
determining, by the caregiver computing device, that the caregiver computing device is within a distance threshold of the caregiver computing device.
